(19) United States
(12) Patent Application Publication
(10) Pub. No.: US 2006/0080632 A1
(43) Pub. Date: Apr. 13, 2006

(54) Integrated circuit layout having rectilinear structure of objects

(75) Inventors: Fuk Ho Pius Ng, Plano, TX (US); Liem Nguyen, Plano, TX (US); David Trawick, Plano, TX (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: MathStar, Inc., Minneapolis, MN (US)

(21) Appl. No.: 11/042,547

(22) Filed: Jan. 25, 2005

Related U.S. Application Data
(60) Provisional application No. 60/615,162, filed on Sep. 30, 2004.

(51) Int. Cl. G06F 17/50

(52) U.S. Cl. 716/17; 716/9

(57) ABSTRACT

An integrated circuit layout pattern is formed from a plurality of objects placed within the layout pattern. Each object has a homogenous communications interface, which is a rectilinear donut structure formed of communications elements surrounding a central object logic area. The communications elements are adapted to route data between the central object logic area and other rectilinear donut structures in the layout pattern.

### CROSS REFERENCE TO RELATED APPLICATION(S)

This application claims priority from Provisional Patent Application Ser. No. 60/615,162 filed on Sep. 30, 2004 and entitled “INTEGRATED CIRCUIT LAYOUT HAVING RECTILINEAR STRUCTURE OF OBJECTS”.

### FIELD OF THE INVENTION

The present invention relates to design and verification of circuit layouts, and more particularly to a system for circuit layout design and verification using arrays of silicon objects where timing is closed a priori.

### BACKGROUND OF THE INVENTION

The transistor density in integrated circuit technology continues to increase; however, the increase in processing potential made possible by the increased transistor density is limited, in part, due to high development complexity, time and costs.

As transistor technology advances, cost and complexity of application specific integrated circuit (ASIC) development continues to increase. Field Programmable Gate Array (FPGA) technology provides a lower cost solution, but lacks the performance. Reconfigurable computing has been viewed as a possible remedy for balancing the costs and performance requirements of complicated applications.

One solution for balancing costs and performance requirements is described in U.S. patent application Ser. No. 10/337,494, filed Jan. 7, 2003 and entitled “SILICON OBJECT ARRAY WITH UNIDIRECTIONAL SEGMENTED BUS ARCHITECTURE”, which is incorporated herein by reference in its entirety.

As process geometry becomes smaller, problems of physical timing-closure and other physical effects such as cross-talking, electromigration and the like become dominant design problems because they require significant resources to identify and overcome. Since the cost of design and verification is proportional to the time of the design and verification process, reducing the design time will reduce the cost.

Therefore, there is an ongoing need for a system and method for reducing the time required to complete the design and verification process of an integrated circuit layout. More particularly, there is an on-going need for a system and method for a reconfigurable layout structure wherein timing-closure issues are resolved. Embodiments of the present invention provide solutions to these and other problems, and offer other advantages over the prior art.

### SUMMARY OF THE INVENTION

An integrated circuit layout pattern is formed from a plurality of objects placed within the layout pattern. Each object has a homogenous communications interface, which is a rectilinear donut structure formed of communications elements surrounding a central object logic area. The communications elements are adapted to route data between the central object logic area and other rectilinear donut structures in the layout pattern.

In another embodiment, a silicon object for mapping to an integrated circuit layout has a rectilinear donut structure and object logic. The rectilinear donut structure defines a substantially symmetric organization of communications elements enclosing an object logic area. The rectilinear donut structure defines a communications interface for communicating between the object logic area and external elements in the integrated circuit layout. The object logic is mapped to the object logic area for performing one or more logical functions. The object logic is communicatively coupled to the donut structure.

In another embodiment, an array of silicon objects disposed in a circuit layout pattern is described. Each silicon object has a homogenous communications structure defining an object logic area. The homogenous communications structure defines a communications interface for communicating between the object logic area and external elements of the array via a fixed arrangement of pinouts. Object logic is mapped to the object logic area for performing one or more logical functions. The object logic is communicatively coupled to the homogenous communications structure.

In another embodiment, a method of designing a layout pattern for an integrated circuit that satisfies timing constraints is described. A plurality of silicon objects is provided. Each silicon object has a rectilinear communications structure and object logic for processing data. The rectilinear communications structure includes communications elements, a clock bus connecting the communications elements, a plurality of pinouts. The plurality of pinouts is arranged along peripheral edges of the rectilinear communications structure and the pinouts are selectively coupled to one or more of the communications elements or the clock bus. Selected silicon objects are placed from the plurality of silicon objects into the layout pattern to form an integrated circuit layout.

### BRIEF DESCRIPTION OF THE DRAWINGS

FIG. 1 is a simplified block diagram of a silicon object according to an embodiment of the present invention.

FIG. 2 is a simplified block diagram of an array of silicon objects of FIG. 1 according to an embodiment of the present invention.

FIG. 3 is a simplified block diagram of elements of a homogenous communications structure or donut of a silicon object according to an embodiment of the present invention.

FIG. 4 is a more detailed simplified flow diagram of the homogenous communications structure or donut of FIG. 3.

FIG. 5 is screen shot of a silicon object with a homogenous communications structure or donut in a graphical user interface of a computer layout design program according to an embodiment of the present invention.

FIG. 6A is a simplified block diagram of an array of silicon objects with interconnecting communication elements of neighboring donuts identified according to an embodiment of the present invention.

FIG. 6B is an expanded, simplified block diagram illustrating interconnection of silicon objects by abutment in a layout pattern according to an embodiment of the present invention.

FIG. 7 is a screen shot of an array in a graphical user interface of a computer layout design program according to an embodiment of the present invention.

FIG. 8 is a simplified block diagram of a silicon object with a homogenous communications structure or donut with a clock ring according to an embodiment of the present invention.

FIG. 9A is simplified block diagram of an array of silicon objects with a clock spine and power rib and mesh overlaid according to an embodiment of the present invention.

FIG. 9B is an expanded simplified block diagram of a two-by-two portion of the array of FIG. 9A showing the interconnections between clock rings within the array according to an embodiment of the present invention.

FIG. 10 is a simplified block diagram of silicon object array illustrating data flow from a neighboring silicon object according to an embodiment of the present invention.

FIG. 11 is a simplified block diagram of a silicon object with a homogenous communications structure or donut containing a clock ring and power mesh according to an embodiment of the present invention.

FIG. 12 is a screen shot of a silicon object with a power mesh overlaid in a graphical user interface of a circuit layout computer program according to an embodiment of the present invention.

FIG. 13 is a simplified block diagram of a conventional circuit layout synthesis process.

FIG. 14 is a simplified block diagram of a object layout synthesis process according to an embodiment of the present invention.

FIG. 15 is a simplified block diagram of a conventional process for producing a gate-level netlist.

FIG. 16 is a simplified block diagram of a process for producing an object netlist according to an embodiment of the present invention.

While the above-identified illustrations set forth preferred embodiments of the present invention, other embodiments are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION OF THE PREFERRED EMBODIMENTS

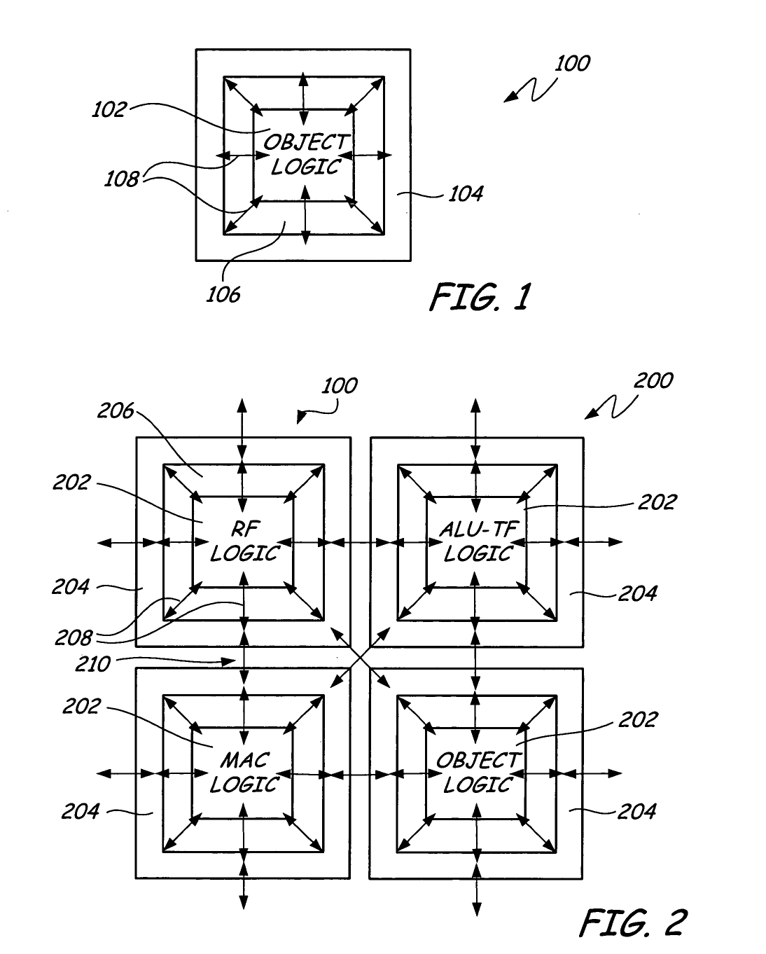

FIG. 1 is a simplified block diagram of a silicon object 100 according to an embodiment of the present invention. The silicon object 100 includes object logic 102 and a homogenous communications infrastructure (or “donut”) 104. As used herein, the term “homogenous” refers to a similar or uniform communications layout pattern for each silicon object 100. The donut 104 is preferably uniformly sized and shaped to facilitate interconnections with other silicon objects 100 to form silicon object arrays. Preferably, the layout pattern for the donut 104 is identical for all donuts in the array. In one embodiment, the electrical connections between adjacent silicon objects is by abutment only. The donut 104 is arranged in a ring-like shape defining a central area 106 sized to fit the object logic 102 and to adjacent silicon objects. Signal interconnections 108 communicatively couple the donut 104 to the object logic 102.

In general, the donut 104 implements a homogenous communication infrastructure and physical layout, which can accept heterogenous programmable processing elements (object logic 102) within central area 106, such as multiply and accumulate (MAC) units, register files, and the like, or function specific object logic 102 such as an arithmetic logic unit (ALU), a content-addressable memory (CAM), a cyclic redundancy check (CRC) generator, an integer/real/complex multiplier, a Galois Field multiplier, a memory, or any other combinational or sequential logic function. As used herein, the term “heterogenous” is used to refer to logic that may vary in kind or nature, depending on the specific implementation. The object logic 102 is designed to interface with the communications donut 104, which is in turn designed to interface with other silicon objects 100 in an array of silicon objects.

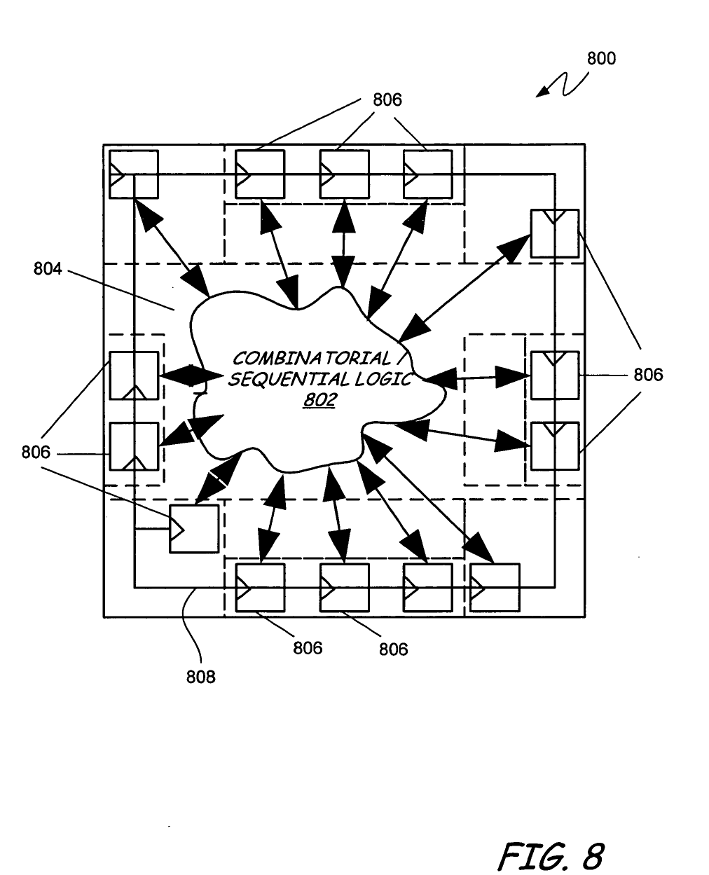

The donut 104 preferably includes a common clock bus (shown in FIG. 8), which synchronizes elements of the communications infrastructure within the donut 104. The donut 104 may be custom designed and is reused by all silicon objects 100 in an array of silicon objects. By implementing the communication infrastructure in a consistent, synchronous donut 104, assembly of the array of silicon objects 100 becomes a trivial construction. Since each donut 104 embodies a consistent and synchronous communications infrastructure and all communication are handled by the donut 104, timing is correct by construction among silicon objects 100 in the array. The donut 104 confines the conventional place-and-route timing-closure issue to a manageable scope, namely timing closure and signal integrity within the object logic 102 and between the object logic 102 and the donut 104.

The donut 104 separates the communications from the object logic 102, thereby making it possible to design object logic to fit the central area 106 and to interface to a standardized communications interface (the donut 104). This makes it possible to design and synthesize a layout of a circuit in less time than conventional techniques, while making full use of existing process technology. In addition, the synthesis of each silicon object 100 is done only once and the silicon object 100 can then be reused multiple times, thereby amortizing the design costs across all designs that use the particular silicon object 100.

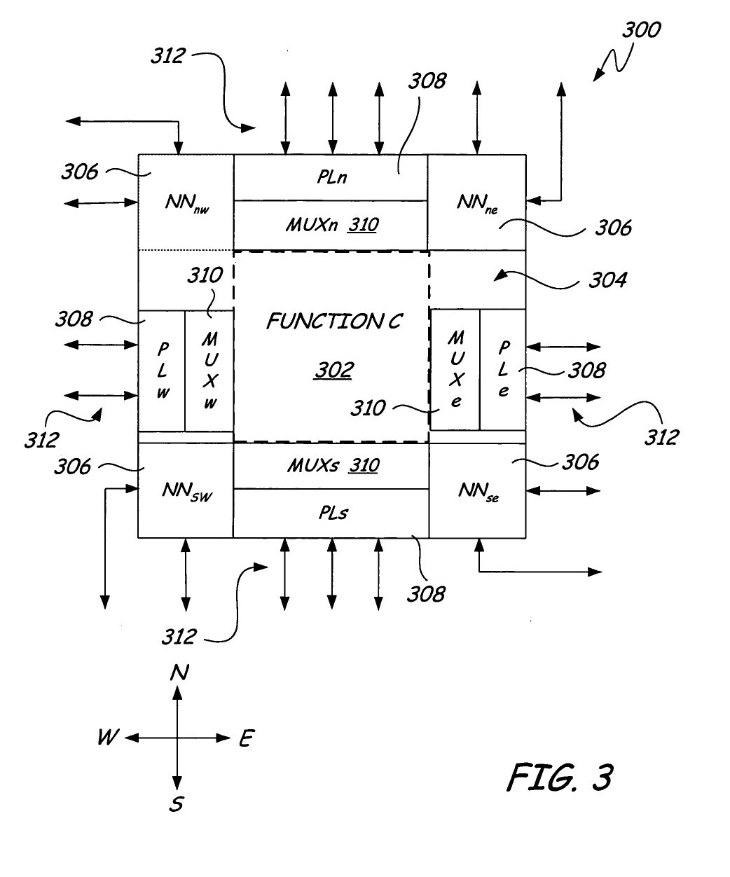

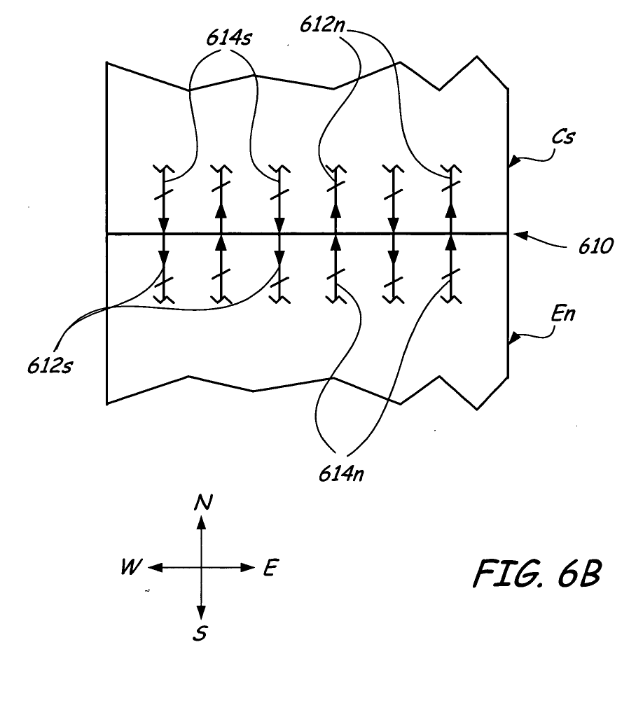

FIG. 2 is a simplified block diagram of a two-by-two array 200 of silicon objects 100. Each silicon object 100 includes object logic 202 and a homogenous communications interface 204 (donut 204). The object logic 202 is disposed within central object logic area 206 defined by the donut 204 and is communicatively coupled to the donut 204 by communication paths 208. In one embodiment, for example, communication between silicon objects 100 is achieved by abutment (as shown in FIGS. 6A and 6B). Specifically, since the communications interface 204 is standardized and is incorporated in each silicon object 100, abutment of one silicon object 100 to another results in an interconnected array 200 of silicon objects.

It should be appreciated by workers skilled in the art that the donut 204 decouples the communications interface from the logical or functional element of the silicon object. Consequently, timing can be closed or standardized for the donut 204, which is reused for each silicon object. The object logic 202 can then be adapted to interface with the donut 204, and interconnection of the entire silicon object array 200 becomes trivial.

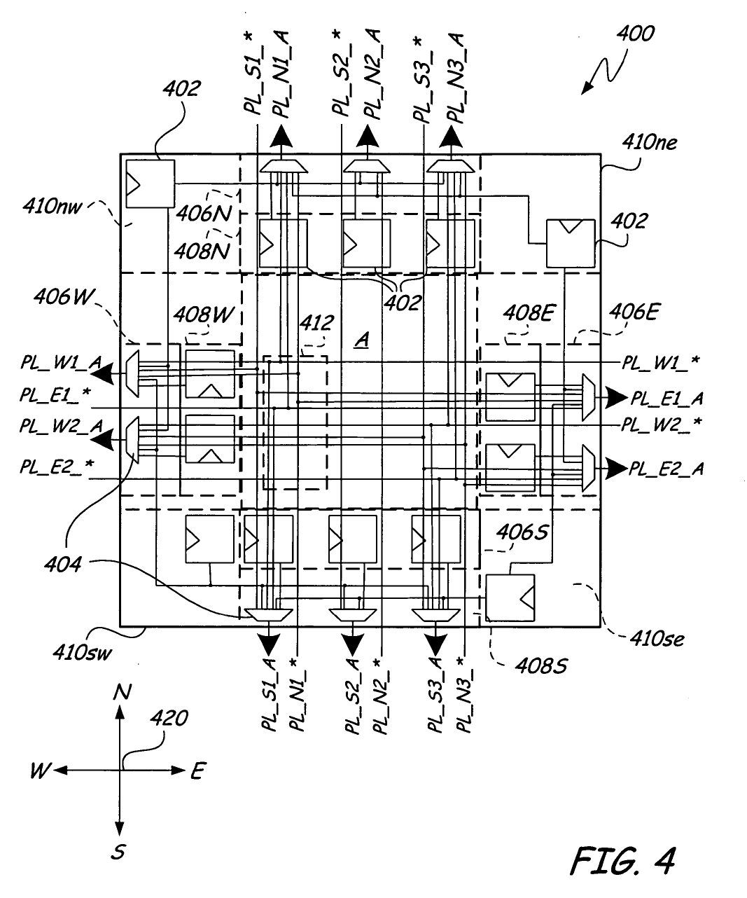

FIG. 3 is a simplified block diagram illustrating the homogenous communication infrastructure, physical layout and object logic of a silicon object 300 according to an embodiment of the present invention. The silicon object 300 includes object logic 302 and the communications donut 304. As previously discussed, the object logic 302 may include programmable processing elements or fixed function object logic.

The donut 304 includes functional communication blocks common to each silicon object 300. The donut 304 includes nearest neighbor communication blocks 306, party line communication blocks 308 and multiplexers 310. In general, each functional communication block is identified directionally according to north, south, east and west directions indicated by arrows 312. Thus, nearest neighbor communication block 306 in the lower left-hand corner of the silicon object 300 is labeled “NN_{sw}” for nearest neighbor (southwest).

When organized into an array, the silicon objects 300 communicate with adjacent silicon objects through the nearest neighbor communication blocks 306 or through one or more of a plurality of “party lines”, which extend in orthogonal north, south, east and west directions, as indicated by arrows 312, which are coupled to the party line communication blocks 308. Non-adjacent silicon objects 300 are coParty lines are unidirectional segmented buses that communicate in vertical and horizontal (Manhattan) directions. A bus is “segmented” in that the bus passes through at least some combinational logic (e.g. object logic 302) and/or a register of the donut 304 from one bus segment to the next bus segment. Each bus segment is not required to connect to proximal silicon objects 300; however, depending on the specific implementation, party line segments may connect to adjacent silicon objects through the donut 304.

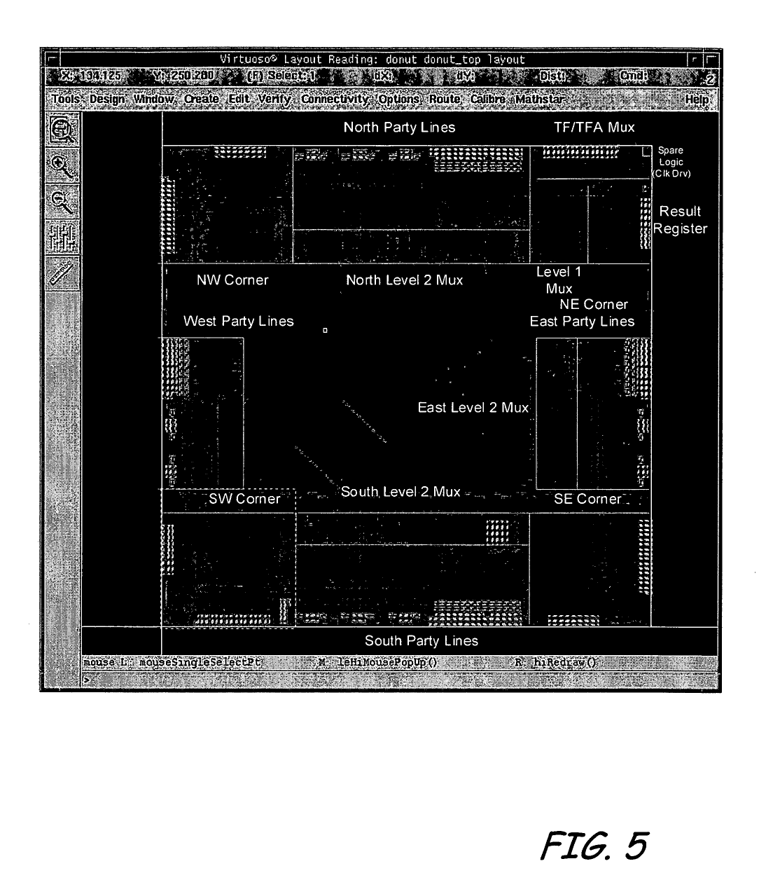

FIG. 4 is a simplified diagram of the re-configurable fabric underlying a homogenous communications donut 400 of a silicon object according to an embodiment of the present invention. In a preferred embodiment, each silicon object includes a communications donut 400, which couples the object logic of the silicon object to a larger array comprised of a plurality of silicon objects.

Each communications donut 400 is comprised of a plurality of registers 402 and multiplexers 404. For the sake of clarity, the communications donut 400 is associated with silicon object “A”. Signals are labeled according to the silicon object that drives them. Signals that are driven from outside the silicon object A are suffixed with “_*” in FIG. 4. For example, in the northerly direction, the communications donut 400 receives a signal or group of signals “PL_N1_*” from outside of the silicon object A. Communications donut 400 also drives a signal, PL_N1_A to another silicon object in an array of silicon objects.

In the vertical direction (north), three party lines extend northward (and are labeled with notations N1, N2 and N3); and three party lines extend southward (S1, S2, and S3). Two party lines extend westward and eastward (W1 and W2, and E1 and E2, respectively).

In general, communication proceeds synchronously. Communication channels (party line or nearest neighbor) are driven by registers. A receiving silicon object loads a received signal into a register and reads the control signals and/or data in the next clock cycle. The nearest neighbor channel connects through the nearest neighbor block from a nearest neighbor block of an adjacent silicon object, and the nearest neighbor can connect to the processing by the object logic of the receiving silicon object directly. Alternatively, data received through the nearest neighbor block can be loaded into a nearest neighbor register and redirected onto one or more party lines in the next clock cycle. By contrast, party line channels connect to a landing register of a receiving object prior to any processing object logic. The party line channel provides the communication among objects with a deterministic latency.

In general, the donut 400 of the silicon object has ten party line inputs (PL_*_*), ten party line outputs (PL_*_A), party line launch circuit 406, multiplexers 408, party line landing circuit 412, and a function-specific logic block (“core”), which is labeled as “A”. In one embodiment, party line inputs and outputs are each 21-bits wide and include control bits C[3:0], data bits R[15:0] and valid bit V.

Values on party line inputs can be captured, for example, by a landing register 412 (shown in phantom) for use by a logic block or for synchronizing the value with a local clock signal and transmitting the value back onto the same or a different party line through the party line launch circuit 406. The landing register 412 is shown in phantom to indicate that specific placement of the landing register may vary provided that inputs to the landing register mate with input pins in the expected location on a periphery of the donut structure 400.

In one embodiment, the donut 400 includes multiplexers 408 and party line launch circuitry 406, landing circuitry 412 (shown inphantom), as well as nearest neighbor communication blocks 410. In one embodiment, landing circuitry may be omitted from the donut 400. In another embodiment, landing circuitry 412 is omitted from the donut 400 but is included in the logic block as needed. Alternatively, the landing registers may be included in the donut 400.

The landing circuitry 412 may include one or more registers adapted to store data received from one or more of the party lines. Each register of the landing circuitry can capture values from one of two party lines or a result output from the logic block. Each landing registers in the landing circuitry 412 has outputs that are coupled to logic block A and to inputs of party line launch circuit 406. Alternatively, the landing registers may redirect data to a nearest neighbor block 410.

The communications donut 400 is configured to transmit data onto party lines via party line blocks 406 or to transmit data to adjacent silicon objects in an array via nearest neighbor blocks 410. The party line launch circuit 406 can be configured to selectively “pass” a value received from the previous silicon object on one party line to the next segment of the party line on an output, “turn” the value from the previous silicon object to a different party line, or replace the value with a new value from logic block A or landing circuit 412, which can then be transmitted to one of the party line outputs.

For example, a southward traveling data signal is received from a northerly direction by the donut 400 on input line PL_S1_*. The object logic A may be configured with a landing circuit 412 for receiving the data from the signal, which can be stored in one or more registers of the landing circuit 412. The object logic A, on the next clock cycle, can read the data out from the registers of the landing circuit 412, process the data, and send the processed data onto outgoing party line PL_W1_A, PL_E1_A, PL_S1_A, and/or PL_N1_A (or onto any other outgoing party line). In another embodiment, the party line circuit 406 may be adapted to pass the data signals received from a previous silicon object on a party line segment to a next silicon object on a next party line segment, directly, and in any out-going party line direction (e.g. North, South, East or West).

In one embodiment, data received from an adjacent silicon object may be received either over a party line connection or via a nearest neighbor block 410. Data received in a nearest neighbor block 410 may be passed directly to object logic A for processing, or may be clocked into a landing register, and sent out to another silicon object either via a nearest neighbor connection or over party line connections, as desired.

Data processed by the object logic A can be written to registers 408 (north, south, east or west) and driven onto a party line by the party line circuit 406. Thus, at each silicon object, data can be received by the object logic or passed on by the donut 400, depending on control signals associated with the data signal or based on the donut configuration.

Within an array of silicon objects according to an embodiment of the present invention, silicon objects are connected together through their respective communications donuts 400 by a plurality of party lines running in orthogonal north, south, east and west directions as indicated by arrows 420. As previously indicated, party lines are unidirectional segmented buses that communicate in vertical and horizontal (Manhattan) directions. A bus is “segmented” in that the bus passes through at least some combinational logic and/or a register 402 from one bus segment to the next bus segment. Each bus segment is not required to connect to (to land in a landing register of) proximal silicon objects. For example, in one embodiment, a bus segment may connect only to every other silicon object through which it passes. A detailed discussion of the unidirectional segmented bus architecture is provided in U.S. patent application Ser. No. 10/337,494, filed Jan. 7, 2003 and entitled “SILICON OBJECT ARRAY WITH UNIDIRECTIONAL SEGMENTED BUS ARCHITECTURE”, which is incorporated herein by reference in its entirety.

In one embodiment of the present invention, a data path length may be constrained through software to ensure timing closure. A data path length refers to a length of a string of segments over which data may pass without being registered. A data signal may be passed from one silicon object to the next in an array without being clocked into a data register. The data path length is the maximum number of party line segments over which the data may be passed without violating a set-up time of a receiving silicon object. Specifically, if a data path length would be too long, such that the clock skew for such a distance would result in timing violations with respect to data being clocked into a landing register, the data path lengths can be constrained to avoid such set-up time violations. This makes it possible to make timing adjustments for data path lengths without altering the clock speed for the entire chip. For example, if a maximum number of party line segments is seven without violating a receiving object's set-up time, then a constraint may be placed on the data path length requiring a data signal to be clocked into a landing register and relaunched by at least one silicon object in every seven segments. During synthesis of the circuit layout, the routing tools can limit the data path lengths. Specifically, design rules can be used to impose a constraint on party line data transmissions such that data transmitted over a party line must “land” and be clocked through a register of a communications donut 400 every x-number of party line segments before being launched again on the party line.

In general, communication between silicon objects throughout the array of silicon objects proceeds synchronously through the communications donut 400. Channels are driven directly by registers 402. A receiving silicon donut 400 reads control signals and/or data from received signals in the next clock cycle. Channels can be classified to nearest neighbor (NN) and party line (PL). The fundamental difference between the two types is the cycle timing. Nearest neighbor channels connect to the processing logic (object logic) of the receiving silicon object directly. Consequently, data generated by the originating silicon object is processed in the subsequent cycle by the receiving silicon object. Each silicon object can access both control and data values from each of its eight nearest neighbors via the NN channels. Party line channels connect to the landing registers of the receiving object prior to any process logic. Since data and control signals received over the party line are clocked into the landing register on one clock cycle, and are read out of the landing register by the object logic on the next clock cycle, the party line channel provides communications among all objects with a deterministic latency.

By utilizing a homogenous network, the donut 400 can be standardized for all objects in the array, including peripheral devices. The donut 400 is custom designed and re-used by all objects. In one embodiment, the largest silicon object is a single cycle multiply-and-accumulate (MAC) unit, so the basic dimension of the donut 400 was selected to be the minimum area required to contain the custom designed logic of the multiplier by the donut 400. If the logic for a particular object type is larger than the object logic area of the donut 400, the logic can extend to two object logic areas areas.

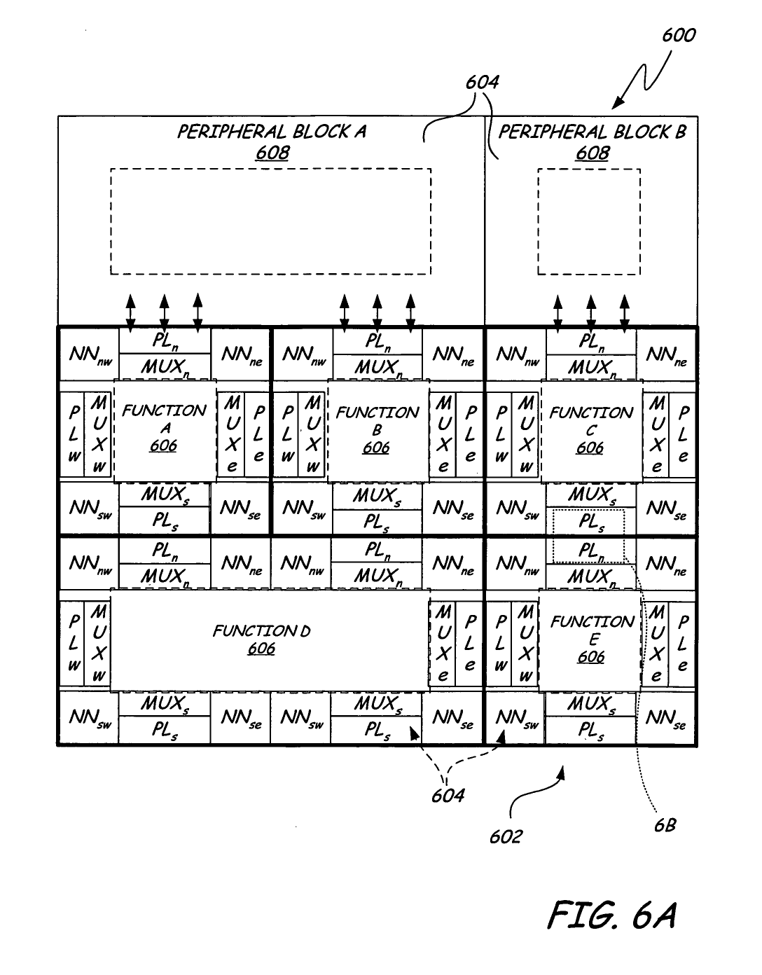

FIG. 5 is a screen shot of a homogenous communications ring or donut layout in a window of the computer program called Virtuoso® according to an embodiment of the present invention. The various elements of the donut are labeled and correspond to elements shown in FIG. 3.

FIG. 6A illustrates a simplified block diagram of an array 600 of silicon objects 602 according to an embodiment of the present invention. Each silicon object 602 includes a homogenous communications interface or donut 604 and object logic 606, which may be programmable or fixed. In this embodiment, function D object logic 606 is two donuts 604 wide. Since the donuts are synchronous and homogenous, the intermediate section including the east and west multiplexers and the east and west party line blocks can be removed, thereby joining two adjacent donuts 604 into a single larger ring in order to accommodate the larger logic function.

Since the donut 604 is constructed hierarchically and symmetrically to the vertical axis and the horizontal axis, the donut 604 can be modified trivially in this manner to adapt to the new multi-unit object. Additionally, peripherals (indicated by peripheral blocks A and B labeled with reference numeral 608), such as external memory controllers, Built-in-self-test (bist) controllers, and the like, can be treated as a multi-unit object with an identical interface. Because of this conformity, the entire array is constructed by abutment automatically in physical design. Element 6B in phantom is shown in a simplified view in FIG. 6B.

FIG. 6B illustrates a simplified, conceptual block diagram of an abutment between adjacent donuts 602 in a layout pattern of the array 600 of FIG. 6A. In particular, party line south block (Cs) associated with a party line block of Function C (element 606 in FIG. 6A) is configured with input lines 612n and output lines 614s, which are arranged in the layout pattern to extend to the periphery of the donut. Each donut of each silicon object in the array has the same configuration, layout pattern, and functional elements. In other words, the donuts are homogenous and identical. Additionally, the design layout of the output pins 614s extend to the periphery of the donut at the same horizontal position (in an x-direction along a peripheral edge of the donut) and at the same layer of the donut architecture as corresponding pins on adjacent donuts in the layout pattern. This allows for two adjacent donuts to be electrically coupled by physical abutment (e.g. contact along a peripheral edge. Specifically, when the donuts are aligned and positioned such that they abut one another, output pins 614s associated with party line block Cs electrically couple to input pins 612s of party line block En associated with function E (element 606 in FIG. 6A). In this manner and along all peripheral edges of the donut (and even diagonally through the nearest neighbor corner blocks of each donut), the donut layout is arranged to facilitate coupling by abutment between adjacent donuts.

It should be understood that the input and output lines 614 and 612, respectively, need not be fabricated on the same layers, provided the output pins mate with the corresponding input pins of the next silicon object in the array. The design layout thus provides a means by which a net is established from one donut to the next in the layout. Additionally, it should be understood that FIG. 6B is conceptual and not drawn to scale. The abutment 610 is a physical line of contact between two adjacent silicon objects in a layout pattern along a peripheral edge of a donut.

Additionally, it should be understood by workers skilled in the art that the electrical connections established by such abutments may include clock signals, power and ground connections, signal routing and so on. Different electrical connections may be established through different layers and at different horizontal locations as desired, according to the homogenous layout pattern of the donut. The donut may be reused in multiple application, or may be redesigned as needed. In general, one of the advantages of the donut is its reusability. Another is the ease with which the layout design can be completed with the interconnections made automatically.

In general, the standardized, homogenous communications donut of the present invention makes it possible to interconnect an array of silicon objects trivially. The wiring input and output pins are fabricated to precisely match corresponding output and input pins of adjacent donuts in all directions. The layout of signal lines 612 and 614 automatically align so that corresponding signal wires automatically connect to one another, thereby connecting one silicon object to the next in the array. When the silicon objects are placed adjacent to one another in the layout pattern, no additional routing is required between silicon objects.

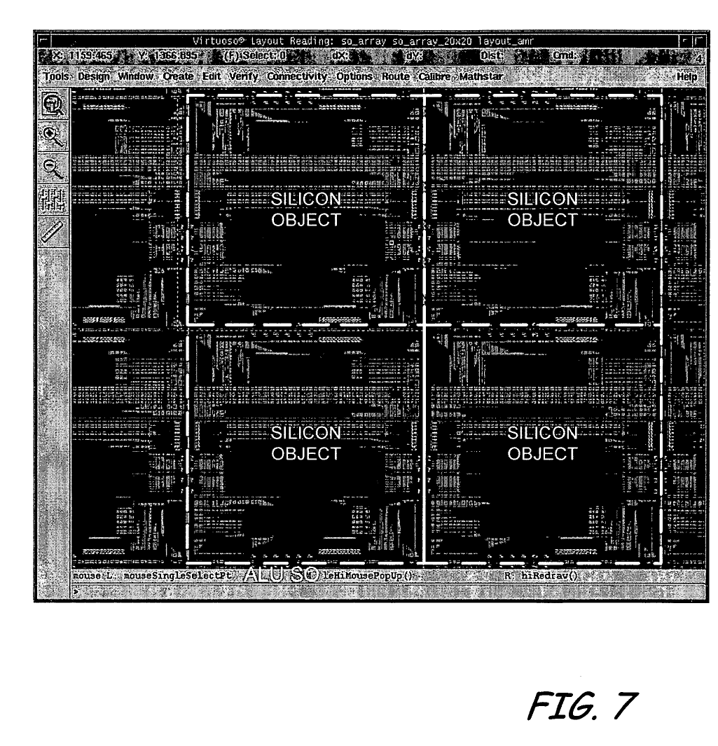

FIG. 7 is a screen shot of a layout of an array of silicon objects coupled by abutment in a window of the computer program called Virtuoso® according to an embodiment of the present invention. The outline of each silicon object is highlighted with a phantom line to illustrate the abutments, and each silicon object is shown in phantom to indicate the general location of the functional logic within the layout.

FIG. 8 is a simplified block diagram of a silicon object 800 according to an embodiment of the present invention. The silicon object 800 includes combinatorial/sequential logic 802 (object logic 802) and a homogenous communications interface or donut 804. The donut 804 is provided with a plurality of registers 806 adapted to store data read from one or more party lines or nearest neighbor connections. A common clock bus 808 is provided within the donut 804 to synchronize the registers 806. The clock bus 808 synchronizes all the registers within the donut 804, such that data received by the donut 804 for processing is synchronized to the clock signal before being read into the object logic 802. If data is received from a nearest neighbor through a nearest neighbor block, it may be trusted as being synchronous because clock skew between adjacent silicon objects is minimal (meaning it can be neglected for the purpose of signal and data integrity).

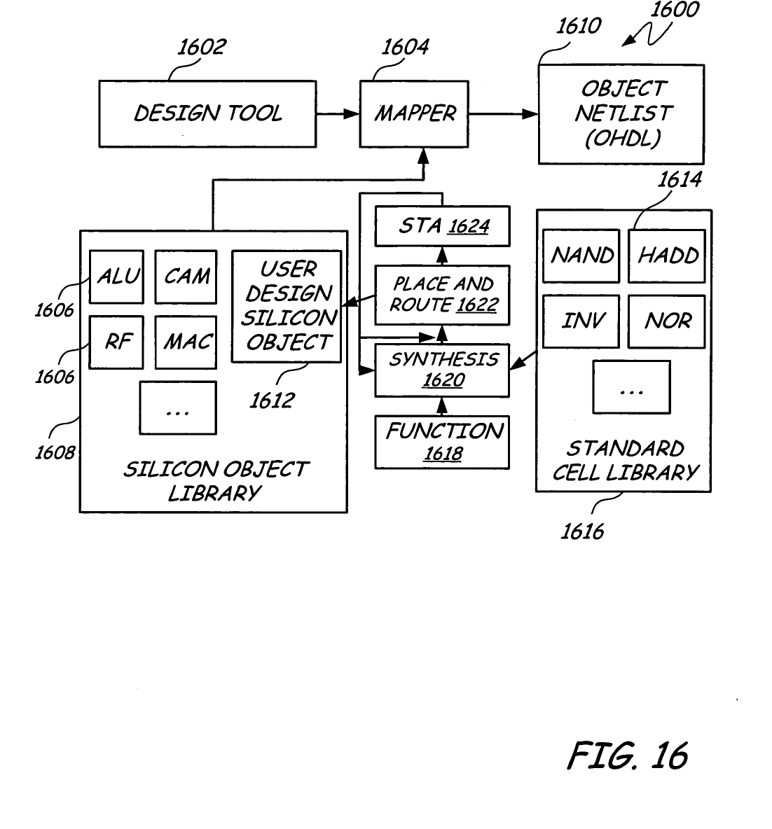

In general, the donut 804 includes a buffer in each corner of the donut structure, to which the common clock bus 808 is coupled. During synthesis, a design tool in conjuction with a mapper (as discussed with respect to FIG. 16) couples one of the buffers of a donut 804 of silicon object 800 to a clock spine of the integrated circuit layout. Each donut 804 within an array of silicon objects 800 receives the clock signal via a buffer either directly from the clock spine or from a wire segment coupling the buffer to an adjacent silicon object. In general, a rib segment may extend from silicon object to silicon object in an array, coupling a clock bus 808 of each silicon object to the master clock spine.

Since all communication between objects is handled by the donut 804 which is fully synchronous (because of the common clock bus 808), timing is correct by construction among objects, and physical effects can be readily accounted for. The only requirement is that timing closure and signal integrity must be correct within the object logic 802 and between the object logic 802 and the donut 804.

To continue the same approach, the interface of the donut to the internal logic of each block is characterized and standardized. Thus, the integration of the computational logic 802 is easily integrated by enforcing the scope of timing closure and logical design into a relatively insignificant area.

The present methodology confines the conventional place-and-route-and-timing closure issue to a manageable (localized) scope. One major advantage of this methodology over prior art techniques is that it takes full advantage of the existing process technology on a much more rapid schedule. Rather than a design cycle measured in months and years, the present invention allows for a design cycle that can be measured in weeks and months. As the technique advances or as more and more silicon objects are synthesized, the technique may allow for a design cycle measured in days and weeks. In addition, timing closure and signal integrity for object logic need only be checked once per object type. Once the timing closure and signal integrity are obtained, the timing across objects in the array is correct by construction. Consequently, the cost of timing closure and signal integrity are confined to each new silicon object and are amortized across all designs with that particular object, thereby reducing cost and design time.

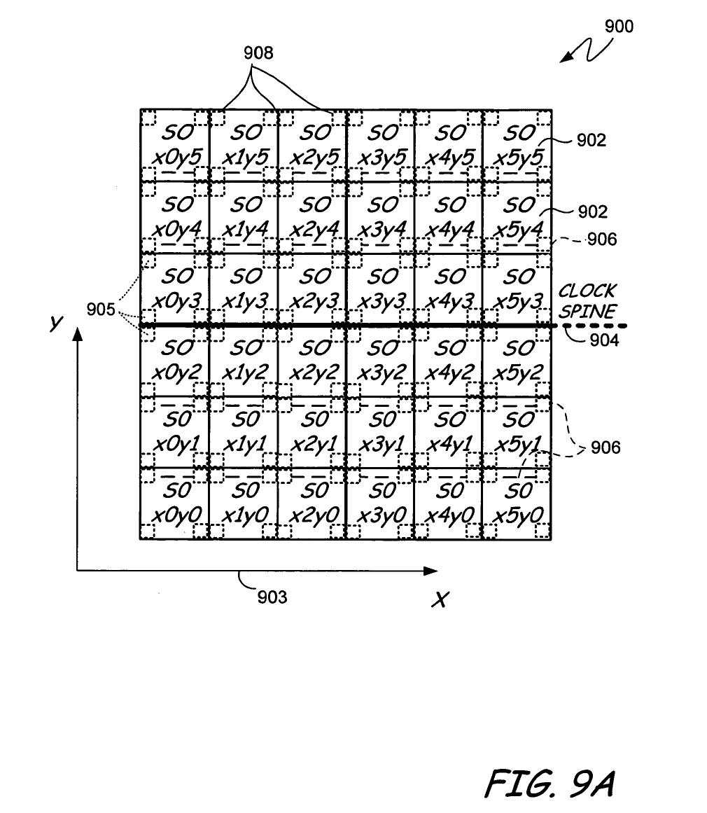

FIG. 9A illustrates a simplified array 900 of silicon objects 902, which are coupled by abutment. In general, the homogenous donut architecture renders clock skew due to propagation delays along the conductor into completely predictable and trivial calculations. In particular, since the array 900 of silicon objects 902 is arranged in a symmetric matrix, and since each silicon object has a consistent size and shape, a timing delay associated with the clock signal as it is received at each silicon object is completely predictable.

For example, silicon object x0y0 is directly coupled to the clock spine 904 via a clock buffer 905 in a corner of the silicon object, and therefore has a clock signal that is approximately the same as a clock signal of the clock spine 904. Other silicon objects 902 may be coupled to the clock spine 904 directly through a buffer 905, or may receive a clock signal through abutment to another silicon object 902.

If the clock signal is received via abutment, a buffer 905 in one silicon object is coupled to a buffer in the adjacent silicon object 902 via a wire segment (not shown). For each silicon object 902 that is coupled directly to the clock spine 904, the clock signal is assumed to be correct. For silicon objects 902 coupled to the clock spine 904 indirectly through an adjacent silicon object 902, the clock skew is predictable, and timing can be readily adjusted with a simple algorithm. Specifically, the skew from x0y0 to x0y1 is the same as the skew from x0y2 to x0y3 and so on. Since each donut is identical, the skew is exactly uniform across the array of objects. Thus, the donut 902 renders clock skew correctable by a trivial calculation.

The homogenous and synchronous donut architecture of the present invention provides the opportunity to employ a scalable symmetric clock tree, such as fish-bone or H-tree for the design. Specifically, by constructing the clock tree from tracks in the layout pattern and clock buffers provided in the rectilinear, homogenous and synchronous donut structures of the array, a clock tree can be scripted readily, and is extendable throughout the array as needed. Since the homogenous and synchronous donut structure has the same dimensions for each instance throughout the layout pattern, clock skew between blocks is predictable, and the overall skew performance is then satisfied. Ones can be automatically generating using a simple script. The overall skew performance is then satisfied.

Ribs 908 are coupled to clock spine 904. In one embodiment, the ribs 908 couple to the clock spine 904 through the buffer 905 of a silicon object 902. The ribs 908 with the clock spine 904 represent an scalable symmetric clock tree. The clock may be implemented in an H-tree or fishbone-type clock tree arrangement. Mesh 906 illustrates a voltage wire extending across the array 900.

Because the donut 902 is symmetric and because all registers are located in a periphery of the donut, the clock loading is balanced. The common clock bus can be part of the donut, and the clock tree can distribute clock signals to the clock ring bus architecture of the various donuts 902 (as is shown in greater detail in FIG. 9B).

FIG. 9B is a simplified expanded block diagram of the array of a two-by-two portion 900B of the array of FIG. 9A. The portion 900B is comprised of four silicon objects 902 (x0y3, x0y4, x1y3, and x1y4). Each silicon object is comprised of a communications donut 912 and an object logic area 914. Each communications donut 912, in addition to communications elements (shown, for example, in FIGS. 3, 4, 5, 6A, and 8-11), contains a clock bus 910 (also shown in FIG. 8). Generally, each corner of each silicon object 902 has a spare cell block 916 (not drawn to scale in order to show the clock connections). Each spare cell block 916 contains spare clock buffers 905, logic inverters and flip-flops (not shown).

These spare clock buffers 905 make it possible to construct a fishbone clock tree using the spare clock buffers 905. For example, a southeast clock buffer 905 of silicon object 902 (identified as x1y3) couples to the clock spine 904 to route clock signals along the clock spine 904 in an East-West layout. Since the locations of the clock buffers 905 are deterministic (meaning the layout pattern is identical for all donut structures 912 in the array, it is possible to use the donut structures 912 to generate a scalable clock tree. Specifically, clock tracks (such as clock spine 904) can be reserved in the layout pattern of the donut structure 912. The connections from the spare clock buffers 905 to the clock tracks can be scripted during layout to generate the clock tree. As shown, a second spare buffer 905 in the southwest corner of the silicon object 902 (identified as x1y3) is coupled to the East-West clock spine 904 and is adapted to route the clock signal onto North-South clock rib 908.

In the embodiment shown, all four silicon objects 902 derive their clock signals from the North-South clock rib 908, which is coupled through the Northeast, southeast, northwest, and southwest corners of silicon objects x0y3, x0y4, x1y3, and x1y4, respectively. Here, clock skew between the four silicon objects is negligible. However, since the size of the silicon objects 902 is deterministic, clock skew is predictable.

By building the clock tree through the spare clock buffers 905 provided in each corner of each silicon object 902, an extra processing step is not necessary to place and route the clock tree. Similarly, in the same spare cell block 916, it is possible to script the generation of a global reset tree using the spare flip flops (not shown). Unused spare cells can be tied down to reduce power and noise.

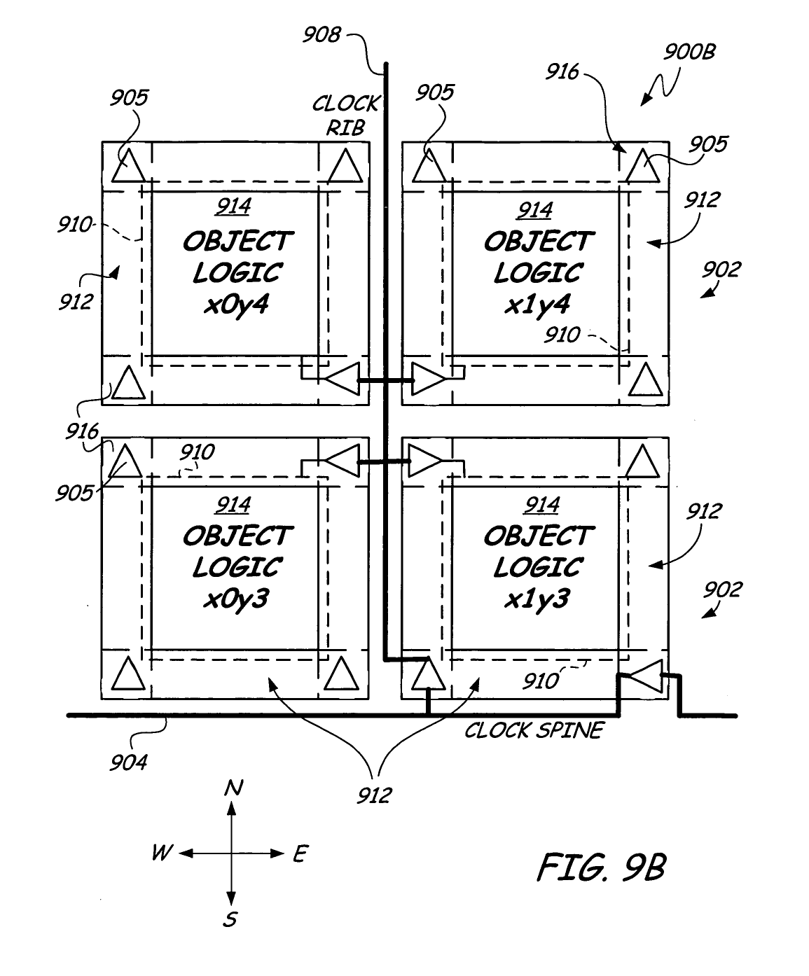

FIG. 10 is a simplified block diagram of a silicon object array 1000 according to an embodiment of the present invention. Each silicon object 1002 is provided with a nearest neighbor communication block 1004 at each corner (NW, NE, SW, and SE) of the object 1002. As shown, data driven by nearest neighbor communication block 1004ne is input directly to the object logic of the neighboring silicon object on the next clock cycle, passing through the nearest neighbor block 1004nw without clocking into a register. The received data can be processed and then sent over the party line 1008, for example, to a non-adjacent silicon object, where it is received in a register on the next clock cycle. Alternatively, the received data can be forwarded to any of the eight adjacent silicon objects via a nearest neighbor communication block 1004. Alternatively, data may be received by nearest neighbor block 1004nw from nearest neighbor block 1004ne and clocked into a register, before the data is launched onto a party line or transmitted to another nearest neighbor in an array.

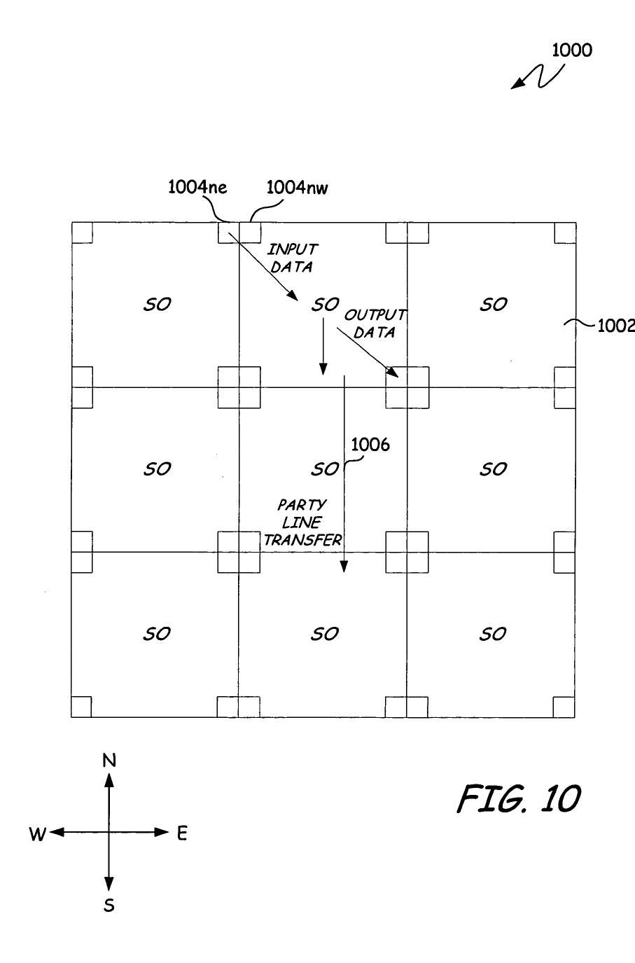

FIG. 11 is a simplified block diagram of a silicon object 1100 according to an embodiment of the present invention. The silicon object 1100 includes object logic 1102 and a homogenous communications donut 1104. A common clock (or clock ring) 1106 is provided within the donut 1104 to synchronize the registers of the communications donut 1104.

Because of the symmetric nature and because launching registers are located in the periphery of each silicon object 1100 as part of the donut structure 1104, the clock loading is balanced across the silicon object 1100. The clock bus or ring 1106 can be part of the donut 1104, and the clock tree (of the silicon array) delivers a clock signal to the clock bus 1106 of each silicon object 1100, either directly or indirectly. Because of the small size of the silicon object 1100, the clock skew within a silicon object 1100 is practically insignificant.

Finally, a conductive power bus is shown, which overlays the silicon object 1100, preferably at a top metal layer, such as metal layer 8, for an integrated circuit having eight routing layers. The conductive power bus 1108 may extend over the peripheries of the silicon object 1100 at locations corresponding to a power pin fabricated to a periphery of the silicon object 1100 to deliver power to the donut 1104, which in turn delivers power to the object logic 1102. The conductive power bus 1108 are routed in a grid across the area of each silicon object at regular spacing intervals. Individual components within the silicon object can be supplied with power by routing power and ground straps to these power buses. With such power grids, the overall power mesh may then be connected by abutment of each of the silicon objects 1100 in an array. Since peripheries share the same rectilinear donut 1104 or donut-like interface (having a homogenous layout), the power bus 1108 may extend over the peripheries to power pins of the donut 1104, which can interconnect on adjacent silicon objects.

The power grid 1108 may readily be tapped by one or more silicon objects 1100, and power can then be shared with other silicon objects in an array via the donut 1104. Additionally, if the power grid 1108 is laid out on metal layer 8, the silicon objects 1100 and the layout simplification provided by the donut architecture and associated methodology can readily be applied to flip-chip technologies, with no adjustment for power being necessary.

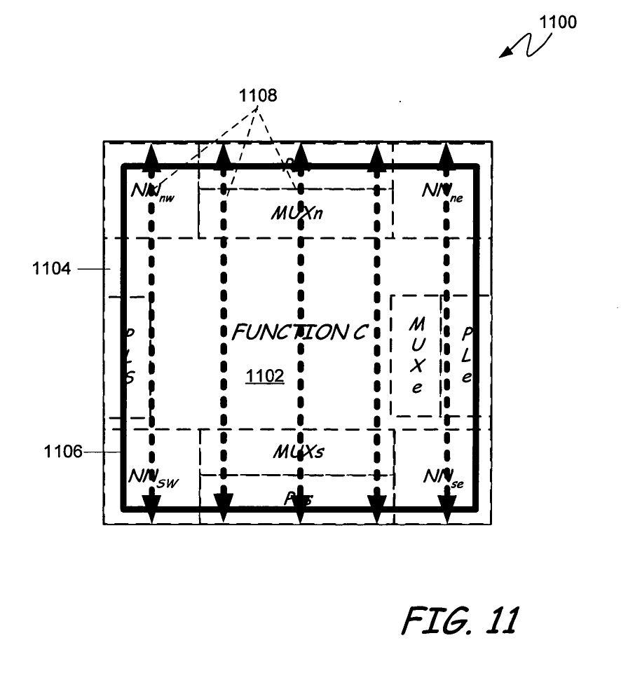

FIG. 12 is a screen shot of a layout of an array of silicon objects coupled by abutment and with a top layer power grid within a window of the computer program called Virtuoso® according to an embodiment of the present invention.

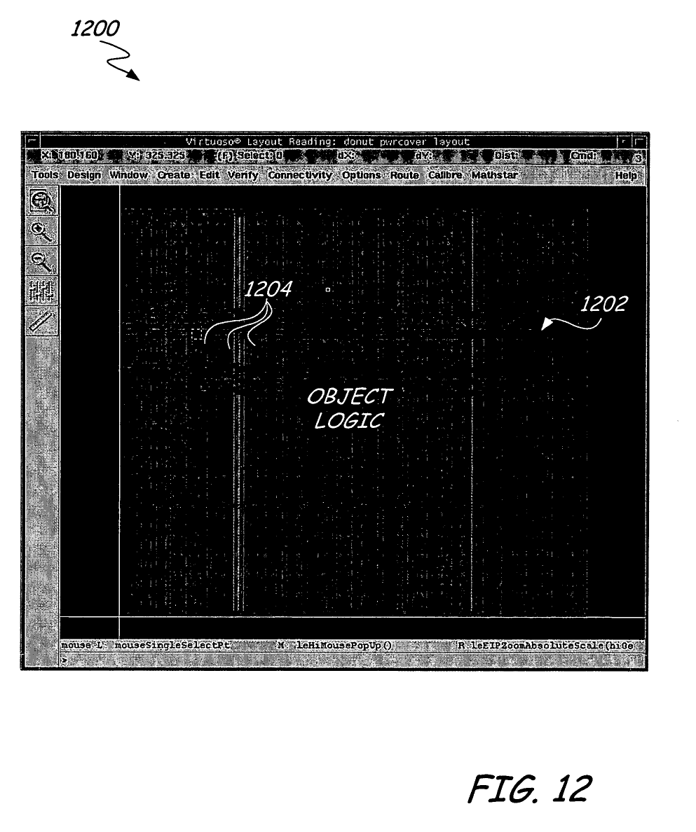

FIG. 13 is a simplified block diagram of a conventional electronic system level (ESL) design process 1300 using an ESL design tool 1302. The ESL design tool 1302 translates the designer's concepts into Hardware Description Language (HDL) code, and the HDL code is synthesized into cells stored in a standard cell library 1304 (step 1306). The cells are placed and routed (step 1308), and timing analysis is performed (step 1310). Depending on the results of the timing analysis (step 1310), synthesis (step 1306) and/or place and route (step 1308) may be repeated several times. The dis-association between the ESL design tool and the HDL level code remains a big gap. Additionally, since the backend environment is typically Verilog or VHDL based, the performance advantage of silicon objects are typically lost during the verification phase. In particular, during timing resynthesis, the layout and routing may be adjusted by the design tool, thereby altering the design layout and rendering the a prior timing closure afforded by the homogenous donut and the silicon objects ineffective. In order to reap the benefits of the communications donut and the silicon object placement methodology of the present invention, integrity of the silicon objects should be maintained.

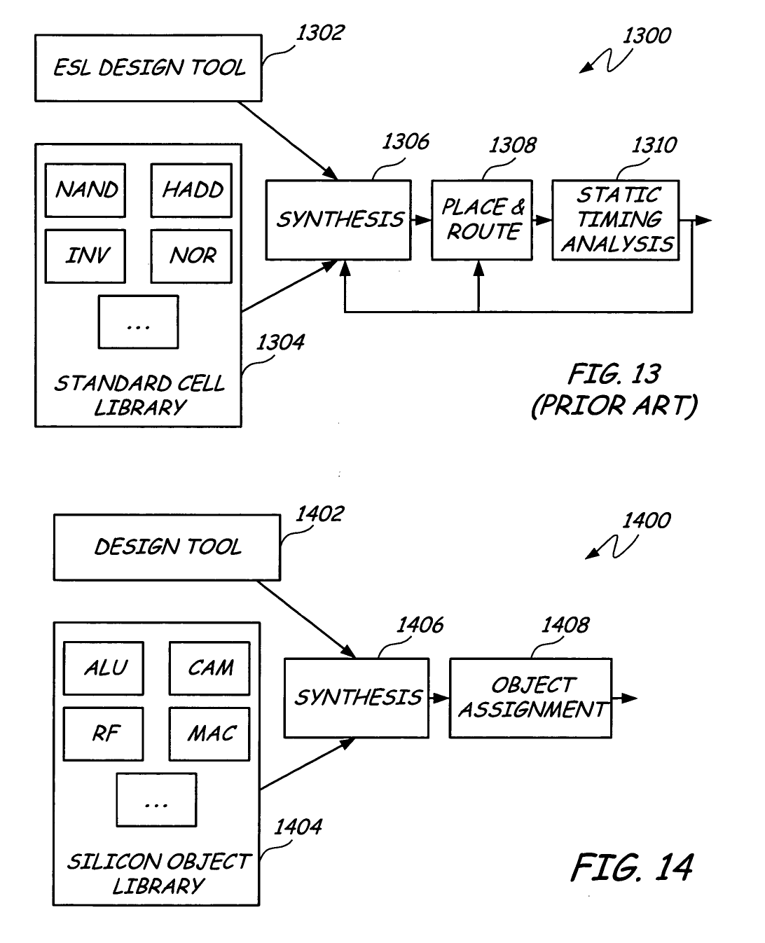

FIG. 14 illustrates a simplified block diagram of a process 1400 for object assignment according to an embodiment of the present invention. The process 1400 includes a design tool 1402 in communication with a silicon object library 1404. The design tool 1402 synthesizes a hardware description into silicon objects from the silicon object library 1404 (step 1406), and the objects are assigned (step 1408). Because timing is resolved for all objects, the entire place-and-route-and-timing-closure issue is eliminated.

When all of the objects are programmed (assigned), the design tool can simulate the programmed algorithm in its logical form without mapping to a physical layer. In this mode, all of the objects are assumed to have direct data dependency (meaning that they are treated as nearest neighbor objects). If the algorithm requires it, a connection between objects can be delayed by a required number of cycles. Once the design tool indicates that the algorithm is behaving correctly, the objects are mapped to their physical locations, which may break the nearest neighbor assumptions. The system is adapted to insert additional delays between blocks as needed and to annotate the silicon object level netlist with the information.

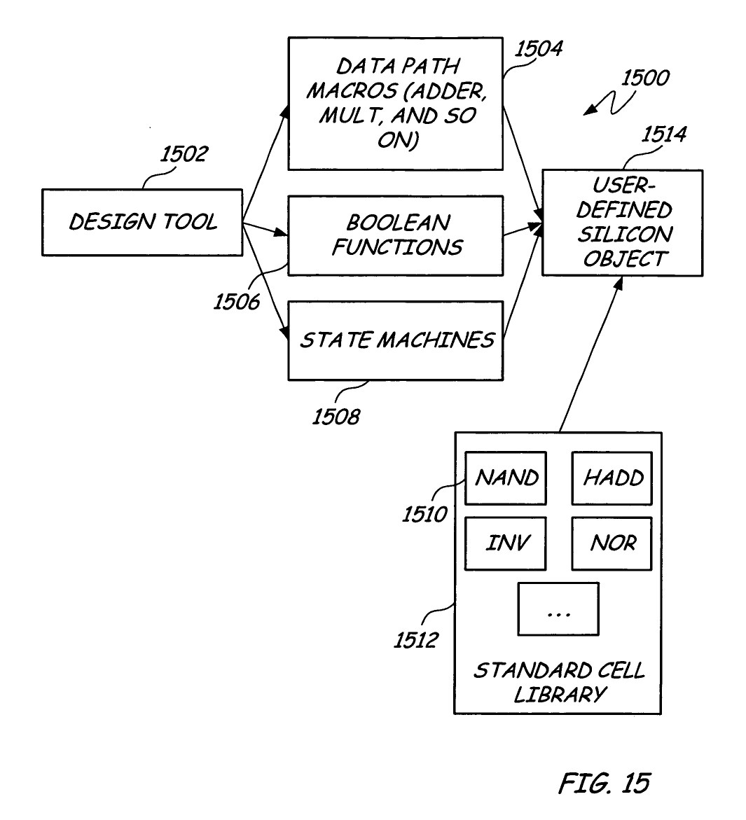

FIG. 15 is a simplified block diagram of a system 1500 for assembling a user-defined silicon object using conventional net-list assembly techniques according to an embodiment of the present invention. The system 1500 includes a design tool 1502 which utilizes data path macros 1504, boolean functions 1506, state machines 1508, and cells 1510 from a standard cell library 1512 to assemble a gate-level netlist 1514. In essence, the tool picks macros, which use instances of standard cells. The resulting silicon object is a list of instances of the standard cells used by the macros and their interconnections, which can be used to place the cells 1510/macros 1504, boolean functions 1506, state machines 1508 and so on into a layout pattern and to route the interconnections between cells. The resulting netlist represents an HDL description of an algorithm, which can be used as a silicon object in the present invention.

FIG. 16 is a simplified block diagram of a system 1600 according to an embodiment of the present invention. The system 1600 includes a design tool 1602, which utilizes a mapper function 1604 to synthesize silicon objects 1606 from a silicon object library 1608 to an object hardware description language (OHDL) netlist 1610.

User designed silicon objects 1612 having a specified function 1610 can be synthesized to the silicon object library 1608 from standard cells 1614 in a standard cell library 1616. The function 1618 is synthesized into the cells 1614 at step 1620. The cells are placed and routed within a silicon object layout pattern at step 1622. Using the placement and routing data, static timing analysis is performed on the hardware description at step 1624, and the process is repeated iteratively until the timing and layout is complete. Preferably, the user designed silicon object 1612 conforms to the timing requirements of the homogenous communications interface or donut, into which it will be placed by the mapper, such that timing closure of the silicon object is complete at mapping.

With the standardization of the donut and the clock tree structure, the donut may be designed using custom techniques to minimize area and maximize performance. Though the cost and time of custom techniques is more expensive than standard application specific integrated circuit design, the expense is greatly amortized due to its re-usability. Similar to the standard cells which are custom-designed, the basic blocks may also be custom designed for maximum performance and minimal area usage. The synthesis process may then be used, similar to the same process as in an application specific integrated circuit.

Architecturally, it is possible to remove the requirement of a tight global skew control. Instead, the architecture allows a tight skew requirement in small regions (essential within a single donut) and a loose skew control requirement in a global scope.

The present invention introduces a rectilinear structure adapted to provide synchronous communications and a homogenous interface with fixed dimensions, a fixed shape, and fixed pinout layout. The rectilinear structure is a donut, which is sized to host object logic, and to synchronize communications between the hosted object logic and external objects. By clocking communications through the communications donut, timing is deterministic and predictable. Moreover, the donut provides a standardized interface for placing object logic and for realizing reconfigurable interconnection schemes.

Additionally, the donut structure includes a clock ring, which extends through all of the registers of the donut, providing a mechanism for automatic timing and closed layout construction with automatic clock generation. The present invention provides a number of advantages over the prior art. The basic building block has fixed dimension, fixed shape and fixed pinout and layout, facilitating object logic reuse. The logical elements for each building block may be programmable or fixed, and may include various standard silicon object or user defined silicon objects. The internal and external interface is a standardized reconfigurable interconnect fabric (donut). The donut is synchronous. The peripheral blocks share the same donut interface. The donut includes a power grid and a clock ring distribution. The silicon objects in an array of silicon objects may be connected through their communications donuts by abutment in a simple circuit layout. The clock skew requirement, architecturally speaking, is tight in neighboring building blocks and loose in global scope. A clock tree is a scalable symmetric structure. Clock distribution is regular and balanced with each building block. The donut is designed using standard ASIC or custom techniques, although the latter is preferable for performance and chip area. The design cost and time for the donut is amortized across all designs because the one design can be reused in all building blocks and, therefore, all subsequent designs.

Because the reconfigurable donut is synchronous, the construction of the design using these building blocks requires no timing closure. Preferably, the reconfigurable communications donut is a structure with straight edges, such as a rectangle, triangle, octagon, pentagon, hexagon, and the like. Straight edges make abutment interconnections simple to implement, while maximizing layout density. Additionally, because of the synchronous reconfigurable donut, the programmable or configurable element of the interconnect network is forward compatible to future-developed semiconductor processes. No further timing closure is required except with the redesign of each building block. Thus, the timing closure is limited to individual building blocks and not the overall design.

In one embodiment, the present invention is a silicon object comprised of a homogenous communications structure and object logic mapped into the homogenous communication structure. The homogenous communications structure is comprised of communications elements and interconnections surrounding an object logic area, some of which interconnections extend to peripheral edges of the homogenous communications structure in a standard layout that is repeated for each homogenous communications structure in an array of silicon objects. Interconnections between silicon objects in the array may be completed by abutment or by wiring. A clock bus is provided within the homogenous communications structure to synchronize at least some of the communications elements. The clock bus layout is standardized across all homogenous communication structures in the array. The clock bus includes at least one buffer and a wire segment extending from the at least one buffer to the peripheral edge of the homogenous communication structure to facilitate wiring interconnections between clock buses of adjacent silicon objects.

Although the present invention has been described with reference to preferred embodiments, workers skilled in the art will recognize that changes may be made in form and detail without departing from the spirit and scope of the invention.

What is claimed is:

1. An integrated circuit layout pattern comprising a plurality of objects placed within the layout pattern, wherein each object comprises:
a central object logic area; and
a substantially homogenous communications interface having a rectilinear donut structure and having communications elements substantially surrounding the central object logic area, the communications elements adapted to route data between the central object logic area and other rectilinear donut structures in the layout pattern.

2. The layout pattern of claim 1 wherein a first rectilinear donut structure is communicatively coupled to a second rectilinear donut structure by abutment within the layout pattern.

3. The layout pattern of claim 1 wherein each rectilinear donut structure comprises:
a clock bus extending in a closed loop within the donut structure, the clock bus adapted to distribute a clock signal to at least some of the communications elements.

4. The layout pattern of claim 3 and further comprising:
a clock spine or clock rib; and
clock buffers arranged at regular intervals within each rectilinear donut structure, the clock buffers adapted to couple to the clock spine or to the clock rib to deliver or to receive a clock signal, wherein at least one of the clock buffers is coupled to the clock bus of the rectilinear donut structure.

5. The layout pattern of claim 3 wherein each rectilinear donut structure further comprises:
a plurality of registers adapted store and launch data received from one or more communication paths, each of the plurality of registers electrically coupled to the clock bus for synchronously loading and launching data from and to selected ones one or more of the communications paths according to the clock signal.

6. The layout pattern of claim 1 wherein each rectilinear donut structure further comprises:
party line elements adapted to receive and transmit data from and to party line segments;
nearest neighbor elements adapted to receive and transmit data from and to one or more nearest neighbor elements of adjacent rectilinear donut structures within the layout pattern; and
multiplexers for allowing multiple logical signals to be transmitted over a single communication path.

7. The layout pattern of claim 1 wherein each rectilinear donut structure further comprises:
power routing mesh extending over a peripheral edge of the rectilinear donut structure on a first layer to coupled to one or more power pins routed on a second layer of the rectilinear donut structure and extending to the peripheral edge, the power pins adapted to deliver power to the communications elements.

8. The layout pattern of claim 7 wherein the one or more power pins are adapted to mate with corresponding power pins on adjacent rectilinear donut structures to distribute power among adjacent objects in the layout pattern.

9. The layout pattern of claim 1 wherein each rectilinear donut structure has a layout of communication elements and interconnections that is identical to other rectilinear donut structures in the layout pattern.

10. The layout pattern of claim 1 wherein each rectilinear donut structure of the plurality of objects has the same dimensions.

11. The layout pattern of claim 1 wherein each rectilinear donut structure of the plurality of objects has the same shape.

12. A silicon object for mapping to an integrated circuit layout comprising:
a rectilinear donut structure defining a substantially symmetric organization of communications elements enclosing an object logic area, the rectilinear donut structure defining a communications interface for communicating between the object logic area and external elements in the integrated circuit layout; and
object logic mapped to the object logic area for performing one or more logical functions, the object logic communicatively coupled to the donut structure.

13. The silicon object of 12 wherein the integrated circuit layout is comprised of a plurality of silicon objects.

14. The silicon object of claim 12 wherein the silicon object comprises:
a common clock bus extending within the rectilinear donut structure and communicatively coupled to at least some of the communications elements.

15. The silicon object of claim 14 wherein the integrated circuit layout includes a clock spine or clock rib and wherein the rectilinear structure comprises:
clock buffers disposed within the rectilinear donut structure, wherein at least one of the clock buffers is coupled to the clock spine or the clock rib of the integrated circuit layout and to the common clock bus of the silicon object.

16. The silicon object of claim 12 wherein the integrated circuit layout comprises an array of silicon objects of identical dimensions.

17. The silicon object of claim 12 wherein the silicon object has a fixed size and shape.

18. The silicon object of claim 12 wherein adjacent silicon objects on the integrated circuit layout have different object logic within the object logic area.

19. The silicon object of claim 12 wherein the rectilinear donut structure further comprises:
input and output pins extending to peripheral edges of the rectilinear donut structure in a fixed arrangement, which is common to all of the objects.

20. The silicon object of claim 19 wherein the input pins of a first silicon object communicatively coupled with output pins of a second silicon object by abutment in the integrated circuit layout.

21. The silicon object of claim 12 wherein the communications elements comprise:
multiplexers adapted to route multiple logical signals over selected communication paths; and
registers adapted to store and launch data over one or more of the communication paths.

22. The silicon object of claim 21 wherein a landing register is adapted to store data received from a communications path on a first clock cycle, and to launch the stored data from the register on the next clock cycle, thereby synchronizing the data to a clock signal of the rectilinear donut structure.

23. The silicon object of claim 12 wherein the object logic area has fixed dimensions, and wherein the object logic is mapped to fit within the fixed dimensions.

24. The silicon object of claim 23 wherein the object logic is mapped to fit across two or more silicon objects if the object logic requires an area larger than the defined object logic area of the silicon object.

25. The silicon object of claim 12 wherein the rectilinear donut structure further comprises:
a power and ground mesh adapted to coupled to a power and ground layout of the integrated circuit layout to deliver power to the communication elements and to the object logic.

26. The silicon object of claim 12 wherein a plurality of silicon objects are interconnected by abutment in an array, and wherein communications between silicon objects within the array occurs through the rectilinear donut structure.

27. The silicon object of claim 12 wherein the rectilinear donut structure further comprises:
pinouts for transmitting and receiving signals, the pinouts arranged to mate with pinouts of adjacent rectilinear donut structures within an array of silicon objects by abutment in the integrated circuit layout.

28. The silicon object of claim 12 wherein the object logic comprises:
one or more logical functional elements for data processing.

29. The silicon object of claim 28 wherein the one or more logical functional elements are programmable.

30. The silicon object of claim 29 wherein the one or more logical function elements comprises an arithmetic logic unit.

31. An array of silicon objects disposed in a circuit layout pattern wherein each silicon object comprises:
a homogenous communications structure defining an object logic area, the homogenous communications structure defining a fully synchronous communications interface for communicating between the object logic area and external elements of the array via a fixed arrangement of pinouts; and
object logic mapped to the object logic area for performing one or more logical functions, the object logic communicatively coupled to the homogenous communications structure.

32. The array of claim 31 wherein signals transmitted from one silicon object to another pass through the homogenous communications interfaces.

33. The array of claim 31 wherein the homogenous communications interface is adapted to communicatively couple one or more peripheral devices to the array.

34. The array of claim 31 wherein logic associated with the one or more peripheral devices is mapped to the object logic area of the homogenous communications structure.

35. The array of claim 31 wherein if the object logic is too large to map to the object logic area, the object logic area is expanded such that the expanded homogenous communications interface fits an area equal to two or more homogenous communications interfaces.

36. The array of claim 31 wherein the homogenous communications interface further comprises:
a clock bus extending in a closed loop through the homogenous communications interface, the clock bus communicatively coupled to a clock spine of the array.

37. The array of claim 31 wherein the homogenous communications interface further comprises:
a power grid comprised of a power/ground mesh extending throughout the homogenous communications structure and to peripheral edges of the homogenous communications structure, the power/ground mesh electrically coupled to a power/ground mesh of a circuit layout.

38. The array of claim 37 wherein power is supplied a particular silicon object within the array and delivered to other silicon objects of the array by abutment interconnection of identically arranged power pinouts on adjacent silicon objects.

39. The array of claim 31 wherein each silicon object has the same dimensions.

40. The array of claim 31 wherein the homogenous communications interface comprises a standardized layout of communications elements, interconnections and pinouts.

41. The array of claim 38 wherein the pinouts of the standardized layout extend to the peripheral edges of the homogenous communications interface and are arranged to mate with corresponding pinouts of adjacent silicon objects by abutment.

42. The array of claim 31 wherein the array is arbitrarily scalable by adding additional silicon objects to the array.

43. The array of claim 31 wherein the object logic area defined by the homogenous communications interface is arbitrarily scalable.

44. The array of claim 31 the circuit layout pattern includes a predetermined clock speed parameter, wherein a clock speed of a circuit layout is fixed according to the predetermined clock speed parameter.

45. The array of claim 44 wherein a maximum number of communication segments over which a data signal may be transmitted between registers is constrained by design to avoid set-up time violations and without adjusting the predetermined clock speed parameter.

46. A method of designing a layout pattern for an integrated circuit that satisfies timing constraints, the method comprising:
providing a plurality of silicon objects, each silicon object comprised of a rectilinear communications structure and object logic for processing data, the rectilinear communications structure comprised of communications elements, a clock bus connecting to at least some of the communications elements, a plurality of pinouts arranged along peripheral edges of the rectilinear communications structure and selectively coupled to one or more of the communications elements or the clock bus; and
placing selected silicon objects from the plurality of silicon objects into the layout pattern to form an integrated circuit layout.

47. The method of claim 46 wherein the step of providing comprises:
defining the dimensions and layout pattern of the rectilinear communications structure;
arranging the pinouts symmetrically along the peripheral edges of the rectilinear structure such that pinouts of adjacent silicon objects in an array of silicon objects are identical on all sides; and
mapping object logic to the object logic area.

48. The method of claim 46 wherein the silicon objects are interconnected by abutment.

49. The method of claim 46 wherein the rectilinear donut structure comprises a plurality of clock buffers regularly spaced within the rectilinear donut structure, the method comprising:
generating a clock tree for the layout pattern by connecting the clock buffers and conductive clock segments defined in the layout pattern.

50. An integrated circuit layout pattern comprising a plurality of objects placed in an array within the layout pattern, wherein each object comprises:
an object logic area; and
a data interface at least partially surrounding the object logic area and having an interface layout pattern, which is substantially identical to the interface layout patterns of the other objects in the array such that all data paths between adjacent objects in the array are coupled by abutment of the interface layout patterns of the adjacent objects within the integrated circuit layout pattern.

51. The integrated circuit layout pattern of claim 50 wherein the data interface of each object further comprises:
communications elements adapted to synchronize and route information between that object and other objects in the array and between the data interface of that object and object logic within the object logic area of that object.

52. The integrated circuit layout pattern of claim 51 wherein the data interface further comprises:
a common clock bus within the data interface and communicatively coupled to one or more of the communications elements.

53. The integrated circuit layout pattern of claim 52 wherein the integrated circuit layout comprises:
a clock spine for carrying a master clock signal for the integrated circuit layout;
and wherein the data interface further comprises:
clock buffers for coupling to the clock spine of the integrated circuit layout pattern or for coupling to the common clock bus.

54. The integrated circuit layout pattern of claim 53 wherein at least one clock buffer in each of the plurality of objects within the array is coupled to a clock signal bus and to the common clock bus.
